(19) United States
(12) Patent Application Publication
(10) Pub. No.: US 2010/0236437 A1
(43) Pub. Date: Sep. 23, 2010

(54) METHOD FOR ACCELERATING A ROTARY PRINTING PRESS

(76) Inventor: Matthias Willi Horn, Holzkirchen (DE)

Correspondence Address: JONES, TULLAR & COOPER, P.C., P.O. BOX 2266 EADS STATION, ARLINGTON, VA, 22202, US

(21) Appl. No.: 12/733,804

(22) PCT Filed: Aug. 8, 2008
(86) PCT No.: PCT/EP2008/060481

§ 371 Date: Jun. 7, 2010

(30) Foreign Application Priority Data
Sep. 20, 2007 (DE) 10 2007 000 952.8
Dec. 6, 2007 (EP) PCT/EP2007/062491

(51) Int. Cl. B41F 1/54

(52) U.S. Cl. 101/484

(57) ABSTRACT

A rotary printing press is accelerated from a standstill after triggering a single control command an a control unit which is executing a program. At least at one checkpoint, while is defined, and during the acceleration process, the program verifies, on the basis of at least one defined admissibility condition, whether or not it is admissible to continue the printing press acceleration process. In case one or more of various conditions for continuing the acceleration process are not met, the acceleration process is stopped by the program. Alternatively, the program may interrupt the acceleration process and may automatically initiate a deceleration process.

### CROSS-REFERENCE TO RELATED APPLICATIONS

This application is the U.S. national phase, under 35 U.S.C. 371, of PCT/EP2008/060481, filed Aug. 8, 2008; published as WO 2009/040178 A1 on Apr. 2, 2009 and claiming priority to DE 10 2007 000 952.8, filed Sep. 20, 2007 and to PCT/EP2007/062491, filed Dec. 6, 2007, the disclosures of which are expressly incorporated herein by reference.

### FIELD OF THE INVENTION

The present invention is directed to a method for accelerating a rotary printing press. The rotary printing press is accelerated from its idle status following initiation of a control command at a control unit which executes a program.

### BACKGROUND OF THE INVENTION

A rotary printing press, which may be used in newspaper printing, for example, and in particular a rotary printing press that operates in an offset printing process, and which preferably is a web-fed printing press, has essentially the following three sequential operating phases in connection with its use in the production of a printed product: set-up, production, shutdown. These three operating phases are customarily repeated for each new print order. Setting up the rotary printing press, during its set-up phase is also often referred to as its makeready phase. During the actual production phase, multiple identical copies of a specific printed product are produced, with that production being based upon a current print order being processed.

A method for starting up a printing press is known from DE 197 46 323 A1. The printing press is automatically started up when a start-up signal appears two times in succession and when, in addition, the following two conditions are met, which two conditions are automatically verified by a press control system. These two conditions are that no start-up signal is present within a first, predetermined time interval, which follows the time of the first appearance of the start-up signal by a predetermined period of time, and that the start-up signal reappears within a second, predetermined time interval, which follows the first predetermined time interval.

EP 0 685 338 A1 describes a safety device for a printing press with a drive, a control system located upstream of that drive, command keys connected to the control system and through which, start-up of the printing press can be initiated, and tone generators which are connected to the control system, and which are usable for emitting an acoustic warning signal followings actuation of one of the command keys. A monitoring device is provided, to which a signal from at least one tone generator can be supplied and which is functionally connected to the drive of the printing press. The drive of the printing press is blocked against starting up, if the monitoring device does not detect an output of an acoustic warning signal. A movement, which is executed by the drive, can preferably be detected by the monitoring device. If the warning signal is not emitted, the drive can be shut down.

A method for accelerating and for stopping printing presses using stored time/or speed dependent sequences for switching individual functions and/or stored acceleration curves on and off for the time and/or speed dependent determination or influencing of the metering of ink and/or dampening agent is known from DE 10 2004 005 602 A1. In particular, at the start of production, or at the restart of production, sequences are modified with respect to their switch on times and/or switch on sequences and/or the path of their acceleration curves based upon correction factors. These correction factors are based upon the surface temperature of the rollers and/or cylinders which are involved in the printing process.

A method for operating a press used in the graphics industry and provided with a computer is disclosed in US 2005/0028700 A1. At least one order that will be processed on the press can be stored in the computer. The computer includes a control device, which defines the properties of the stored order. The control device sets up the press corresponding to the defined properties. The control devices also calculates additional necessary data for processing the order from the existing data and then processes the order. The control device preferably sends a warning message to the press operator when specific parameters of the press are outside of the tolerance limits which are stored in the computer.

An automatic control system for an offset printing press is known from DE 28 46 968 A1. When a single control command is issued to a control unit, the offset printing press is accelerated from its idle status at least up to a first production speed. During such acceleration by the control unit, units of the offset printing press that are involved in executing the current printing process are automatically activated and are adjusted to the execution of the pending printing process. At least at one checkpoint, which is defined during the course of the acceleration, verifies whether it is admissible to continue the acceleration of the offset printing press, based upon measured data that has been collected in the rotary printing press.

DE 10 2004 021 657 A1 describes a method for accelerating a rotary printing press. When a single control command is initiated on a control unit, the rotary printing press is accelerated from its idle status at least up to a first production speed. During this acceleration by the control unit, units of the rotary printing press, that are involved in executing the pending printing process, are automatically activated and are adjusted for executing the pending printing process.

A method for starting up an offset rotary printing press is known from DE 101 06 986 A1. The offset rotary printing press is accelerated from its idle status at least up to a first production speed. During the acceleration by a control unit, units of this offset rotary printing press, that are involved in executing the pending printing process, are activated and are adjusted for executing the pending printing process.

A method for starting up a rotary printing press is also known from JP 11165405 A. The rotary printing press is accelerated from its idle status at least up to a first production speed. During the acceleration by a control unit, units of this rotary printing press that are involved in executing the pending printing process are activated and are adjusted for executing the pending printing process.

A device for automatically controlling the operating processes of a web-fed offset printing press is known from EP 1 155 856 B1. When a printing press operator actuates a single switch, devices of the web-fed offset printing press are actuated automatically and successively. This is accomplished in accordance with predefined steps that are based upon a signal from the switch, to switch each of the devices from a preceding printing run to the subsequent printing run. Thus, by actuating a single switch, all of the devices of the web-fed rotary printing press, that are involved in the printing run, are set-up for a new printing run. The web-fed offset printing press can thus be set up for a new print run within a short period of time. EP 11 55 856 B1 therefore concerns only the steps in an automated setting up of the web-fed offset printing press for a new print order.

A control process for a printing press is known from EP 1 155 853 B1. This control process comprises the following steps: a) cleaning a blanket mounted on a blanket cylinder, b) replacing a printing plate mounted on a plate cylinder with a new printing plate, c) exposing an image onto the new printing plate which has been mounted on the plate cylinder, d) creating an ink film distribution on an ink roller group, with that created ink film distribution corresponding to a next image to be exposed, and e) automatically executing blanket cleaning, plate replacement, image exposure and the creation of ink film distribution in a sequence of steps that are initiated via a single start command.

A device for controlling a printing press is known from EP 0 293 618 A1. Steps that are part of shutting down and/or that are part of accelerating the printing press, and which are executed by various units at different locations in the printing press, are started centrally at a control unit. After this start, these steps are executed automatically in accordance with the default specifications of a program which is running in the control unit. Parameters for individual units, which relate to steps for shutting down and/or accelerating the printing press, are defined in a program mask, which program mask is displayed in a display device that is connected to the control unit.

A method for controlling auxiliary units of a printing press is known from U.S. Pat. No. 5,461,560 A. These auxiliary units are connected to a central control unit. Operating parameters for the auxiliary units can be defined in a program mask which is displayed in a display device that is connected to the central control unit.

A web-fed rotary printing press with an adjustable reel changer for use in accommodating print material webs of different widths is known from DE 44 35 429 A1. This printing press comprises a printing couple with printing cylinders that can be engaged against one another to form printing stations, and further comprises an adjustable folder. The width of the reel changer and the positions of the printing cylinders and of components of the folder are adjusted automatically and in a mutually coordinated manner during the run of the press in order to change over production from a first printed product to a second printed product. These adjustments are supported by a unit for controlling the web-fed rotary printing press.

A process for fully automatic cylinder cleaning in printing presses that are equipped with a central control system and also with automated washing devices is known from DE 43 38 625 A1. The central control system has an expansion, by the use of which, the operating parameters for determining the respective optimal washing sequence programs for each individual washing device are defined by accessing the central printing press control system. The respective optimal washing sequence programs for each individual washing device are determined automatically. The individual washing devices are controlled, in each instance, by the corresponding optimal washing sequence program.

A printing unit having at least four cylinders is known from EP b 1 361 049 A2. This printing unit has a first pair of cylinders comprising a first form cylinder and a first transfer cylinder, and also has a second pair of cylinders comprising a second form cylinder and a second transfer cylinder. The transfer cylinders cooperate in a print-on position. At least the two cylinders of one pair are each driven, both in set-up operation and during production, by their own drive motor, without drive coupling to one of the other cylinders. At least the independently driven transfer cylinder has a speed which is sufficient for washing the transfer cylinder or for feeding in a web, which speed is different from a production speed and is also different from a speed of zero. At the same time, the form cylinder from the same pair, which is assigned to its respective transfer cylinder, has a set-up speed that is different from a production speed and is also different from a speed of zero.

### SUMMARY OF THE INVENTION

The object of the present invention is to provide a method for accelerating a rotary printing press which improves the efficiency of the acceleration of the press.

The object in accordance with the present invention is attained by the provision of a program which is executed, in response to a control command, in a control unit of the rotary printing press. The program verifies an admissibility for continuation of the press acceleration based on at least one admissibility condition which is defined in the program. If that at least one admissibility condition is not met, the acceleration of the press will be either discontinued by the program or will be interrupted by an automatic initiation of deceleration. The verification is performed at least at one checkpoint which is defined in the course of the press acceleration. The press is accelerated following the initiation of a single control command. Parameters that influence the acceleration are adjusted at the control unit.

The method in accordance with the present invention is characterized in that steps that are required for shutting down and/or for accelerating the rotary printing press, and which are performed by various units at different locations in the rotary printing press, are started centrally at a control unit, such as, for example, at a control station of the rotary printing press. After this start, these steps are executed automatically in accordance with the default specifications of a program which is running in the control unit. After the program is started, the shutdown and/or the acceleration of the rotary printing press are executed automatically without additional actuation of the unit performing a relevant step. The parameters for the units, and which are performing the shutdown and/or the acceleration of the rotary printing press, can be defined centrally in the control unit, and can thus be easily adjusted to their respective operating environment and to their desired use. The efficiency of the shutdown and/or of the acceleration is improved because the parameters of the units which are involved in the shutdown are flexible and can thus be easily adjusted as needed. Procedures for shutting down and/or for accelerating the rotary printing press can therefore be adapted within the shortest possible time to modified structural conditions in the rotary printing press, for example, or to modified sequences. A retrofitting of various units in the rotary printing press and/or a replacement of a unit of a certain manufacturer or type with another unit from the same or a different manufacturer, or with a unit of another type, is also facilitated. The flexible adjustability of the parameters of the unit, as needed, allows it to be placed in operation in the shortest possible time, and without the rotary printing press entering an extended idle status. This aspect of the present invention is very important, in particular, for use with a rotary printing press that is intended for newspaper printing.

A further advantage of the method for accelerating a rotary printing press, in accordance with the present invention, is that the shutdown and/or the acceleration of the press is executed by a single operator, and is performed in a shorter amount of time as compared with a conventional shutdown. The rotary printing press is thus available for further production more quickly. Its availability and thus its efficiency are thereby improved.

It is also advantageous, in accordance with the present invention, that the control unit, which may be positioned, for example, at the control station of the rotary printing press, can be used to execute and to operate multiple processes that serve to automate the rotary printing press. For instance, both the process of shutting down and the process of accelerating a rotary printing press can be executed at the same control unit. The latter process places the rotary printing press in a production-ready operating status in a minimal amount of time and in a manner that is convenient for an operator of the rotary printing press.

One preferred method for accelerating a rotary printing press, in accordance with the present invention, is characterized, in particular, in that when a single control command is issued at a control unit, the rotary printing press is accelerated from its idle status at least to a first production speed. During this acceleration of the rotary printing press by the control unit, units of this rotary printing press that are involved in executing the pending printing process are automatically activated and are adjusted for executing the pending printing process.

A method in accordance with the present invention, for accelerating the rotary printing press, has the advantage that a rotary printing press can be started up in a simple manner, with high start-up reliability and without the risk of incurring a web tear. This serves to increase the operational reliability of the rotary printing press and also to minimize the amount of initial waste that such a start-up unavoidably produces, thereby improving the efficiency of the rotary printing press. The start-up of a printing press, in accordance with the method of the present invention, also makes the job of the person who is operating the rotary printing press, such as, for example, a printing press operator, easier. This is true, in particular, considering the complexity of today's rotary printing presses. Such rotary printing presses have a multitude of units that must be adjusted together for a pending printing process, in a mutually coordinated manner, within the shortest possible time, to avoid producing an inefficiently large amount of wasted paper. The rotary printing press is thus reliably placed in a production-ready operating status, in a minimal amount of time, and in a manner that is convenient for an operator of the rotary printing press. In this production-ready operating status, the rotary printing press produces saleable copies of a printed product. If a malfunction occurs and is detected during acceleration of the rotary printing press, the rotary printing press is placed in a defined operating status. This also increases the operational reliability of the rotary printing press, especially with a fully automated, program-controlled operation of the rotary printing press.

### BRIEF DESCRIPTION OF THE DRAWINGS

A preferred embodiment of the present invention is represented in the set of drawings and will be specified in greater detail in what follows.

The drawings show:

FIG. 1 a first program mask for use in executing a process for accelerating a rotary printing press, and displayed by a control unit;

FIG. 2 a second program mask for use in adjusting parameters for the automatic acceleration of the rotary printing press, and displayed by the control unit;

FIG. 3 a first example of an acceleration curve for an automatically executed acceleration of the rotary printing press;

FIG. 4 a second example of an acceleration curve for an automatically executed acceleration of the rotary printing press;

FIG. 5 a schematic side elevation view of a printing unit employing independent-drive technology and with additional units that can be remotely controlled for a shutdown process;

FIG. 6 a program mask for a program for executing the shutdown process;

FIG. 7 another program mask for the program for executing the shutdown process;

FIG. 8 a flow chart illustrating the sequence of the shutdown process.

### DESCRIPTION OF THE PREFERRED EMBODIMENT

Within the context of a production process, the acceleration of a rotary printing press is preceded by a shutdown of that rotary printing press. A description of a method for accelerating such a rotary printing press will accordingly be preceded by the description of a method for shutting down this rotary printing press.

The acceleration of a rotary printing press is also referred to as its start-up or its starting, or as a pre-print run for the pending printing process. Printing couple cylinders of the rotary printing press are brought out of the idle status in a so-called acceleration curve by activating at least one drive, and are accelerated to a speed at which the rotary printing press is producing saleable copies of a printed product to be produced. The following discussion is based upon a rotary printing press, which is embodied as a web-fed rotary printing press, and which is a press which is preferably used in newspaper printing and/or which prints in an offset printing process. The offset printing process that is used can be a conventional, wet offset printing process that uses dampening agent or it can be a dry offset printing process, in which no dampening agent is used. A print substrate that is preferably printed on both sides with this rotary printing press is preferably embodied as a paper web. The paper web is provided on this rotary printing press in the form of at least one paper reel, preferably in the form of multiple paper reels, with each web thereof, for unwinding, being joined, as a partial web, with the others of the overall paper web to be printed in a specific printing process, for example automatically.

The acceleration of the rotary printing press is usually broken down into three sequential phases, in which the rotary printing press is set-up to execute a new print order. When these three sequential phases have been completed, the rotary printing press reaches a first production speed, at which first production speed, the rotary printing press is printing saleable copies of a printed product, such as, for example, a newspaper, produced in the current printing process. Prior to arriving at the first production speed, all of the units of the rotary printing press, which are involved in this printing process, have been set up in a manner suitable for generating this printed product, either manually or in partially automated processes based upon specific units. Beginning at its first production speed, the rotary printing press is usually accelerated to at least one additional, comparatively higher production speed, such as, for example, it is further accelerated to its maximum production speed, in order to process a print order relating to this printing process at this latter established higher production speed.

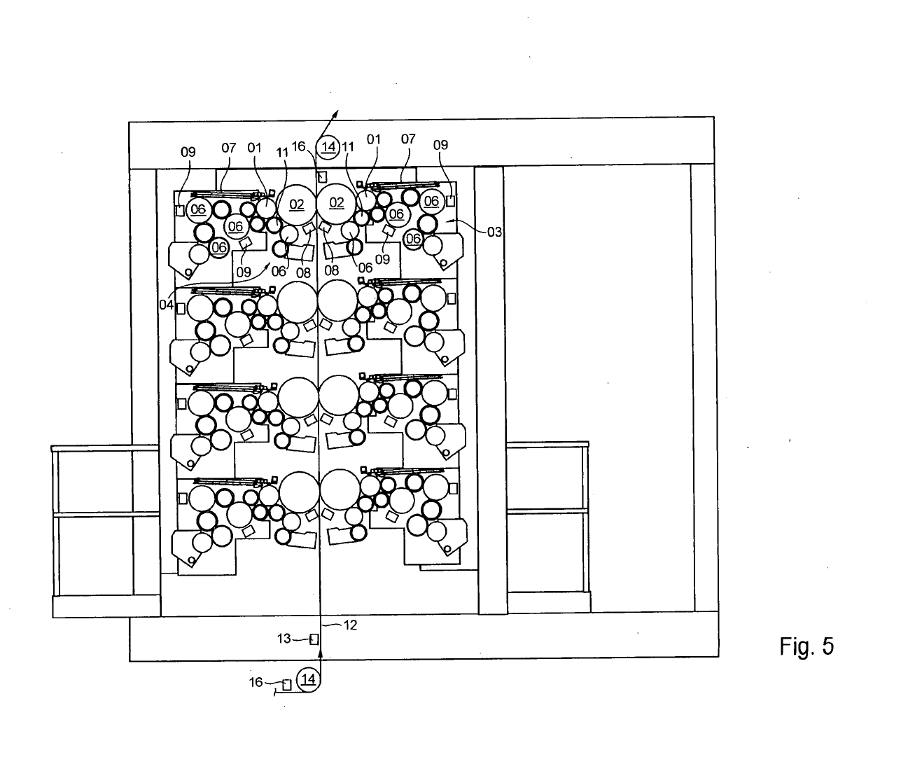

In a first phase of start up of the rotary printing press, the paper web is fed into the rotary printing press at a maximum infeed speed of 5 m/s, for example, and starting from an idle status of the rotary printing press. In the second phase of start up, which printing press operators usually call the “first rapid phase” because it includes, in the acceleration curve, a first acceleration of printing couple cylinders of the rotary printing press that will be involved in the printing process after leaving the idle status, a necessary web tension is built up in the paper web. A run of the paper web is monitored in the rotary printing press with suitable measuring devices, such as, for example, with sensors. In a subsequent of the start up, third phase, the transport speed of the paper web is accelerated to a first level, typically determined by the type of rotary printing press. In this third, acceleration phase, so-called offset commands are selected. The offset commands to be selected are defined in a so-called offset sequence, for example, and relate to an activation of units of the rotary printing press which are necessary for executing the printing process. Ordinarily, these units of the rotary printing press are switched on, in the aforementioned acceleration phase, at preset values for a speed of the printing couple cylinders of this rotary printing press. Involved units are, for example, at least one inking unit and/or at least one dampening unit, and a waste paper sorting gate of this rotary printing press. The printing couple cylinders of the rotary printing press are driven, for example, by electronically controllable or adjustable drives, preferably directly and/or individually and independently of one another. These drives are typically embodied as electric motors, for example. For a more detailed explanation of the rotary printing press or of one of its printing couples, including units integrated therein, reference will be made to FIG. 5 in the associated description.

The offset sequence provides, for example, for a) initiating a delivery of dampening agent from a dampening agent reservoir of the dampening unit, which may be embodied, for example, as a spray dampening unit; for b) engaging at least one of the dampening form rollers that apply the dampening agent to one of the printing couple cylinders against these printing couple cylinders, which are generally embodied as form cylinders; for c) initiating a delivery of printing ink from an ink reservoir of the inking unit, in which, for example, in preferably multiple ink keys that are arranged in a row in the axial direction of the printing couple cylinder, an ink blade assigned respectively to one of these ink keys is opened; for d) engaging at least one of the ink form rollers that apply the ink to one of the printing couple cylinders against this printing couple cylinder, which is generally embodied as a form cylinder; for e) starting an over-dampening and/or an over-inking, and for f), if applicable, closing the waste paper sorting gate that diverts an unavoidably produced amount of start-up waste paper. Additional offset commands may be added based upon the set-up of the rotary printing press and the desired sequence of the production process. Each of the above-described adjustment steps, which are assigned to the respective units and which are initiated by corresponding offset commands, are preferably remotely actuated, for example by the actuating of corresponding operating elements which are located at a control station that is part of the rotary printing press. If a web tear should occur during an initial start-up of the rotary printing press, any already executed offset commands immediately become inactive and are reset.

It is advantageous for at least all of the essential adjustments, and preferably for all of the adjustments, of and to units, which are to be made during acceleration of the rotary printing press, to be made fully automatically, and preferably program controlled, once the printing press operator has initiated a corresponding single control command, for example, at a control unit that is executing the program, such as, for example, at the control station of the rotary printing press. Once this single control command has been initiated by the press operator, the rotary printing press is preferably automatically accelerated from its idle status at least up to a first production speed, without requiring any additional input from the printing press operator. This single control command is preferably initiated by actuating a single operating element, for example at the control station of the rotary printing press.

In addition, it is to be noted, that during acceleration of the rotary printing press, generally two operating situations are differentiated. In a first operating situation, the rotary printing press is accelerated a first time for a specific printing process. A second operating situation relates to a restarting of the rotary printing press in the same printing process, such as, for example, after an operation malfunction, for example following a web tear. At the control unit, which may be located, for example, at the control station of the rotary printing press, a selection option between these two operating situations is presented, preferably defined by the program. Following an acceleration of the rotary printing press, performed for processing a specific print order, the program automatically presents only the option of restarting the rotary printing press. Manually, such as, for example, without this aforementioned program-based default with respect to one of the stated operating situations, an acceleration of the rotary printing press can be optionally performed at any time according to both operating situations. In both operating situations, the respective acceleration of the rotary printing press can take place automatically and without additional input by the printing press operator. In both operating situations, the acceleration of the rotary printing press can differ in terms of the settings of the program to be executed. In this program that controls the respective acceleration of the rotary printing press, at least the nature and sequence of the control commands, referred to here as offset commands, and their respective engagement times, are defined.

In addition to an acceleration of the rotary printing press, at least one further program or at least one further program part, that cooperates with the program for accelerating the rotary printing press, is preferably stored in the same control unit, which may be, for example, the control station of the rotary printing press. This further program or further program part relates to a deceleration of the rotary printing press which is to be initiated following a malfunction or once a print order, which has been executed following the acceleration, has been completed. The deceleration of the rotary printing press is also referred to as its coast down. Following the deceleration, or beginning with the deceleration phase of the rotary printing press, or during this deceleration phase, the shutdown of the rotary printing press can occur, if, for example, a production change is necessary. For the deceleration of the rotary printing press, multiple sequences, which may be provided for various operating situations of the rotary printing press, can also be stored in the control unit of the rotary printing press. These sequences can be automatically or manually selected based upon a current operating situation of the rotary printing press. One selection criterion for use in determining which of the sequences can be, or is selected for the deceleration of the rotary printing press can be the speed of the rotary printing press, at the time the deceleration sequence is chosen.

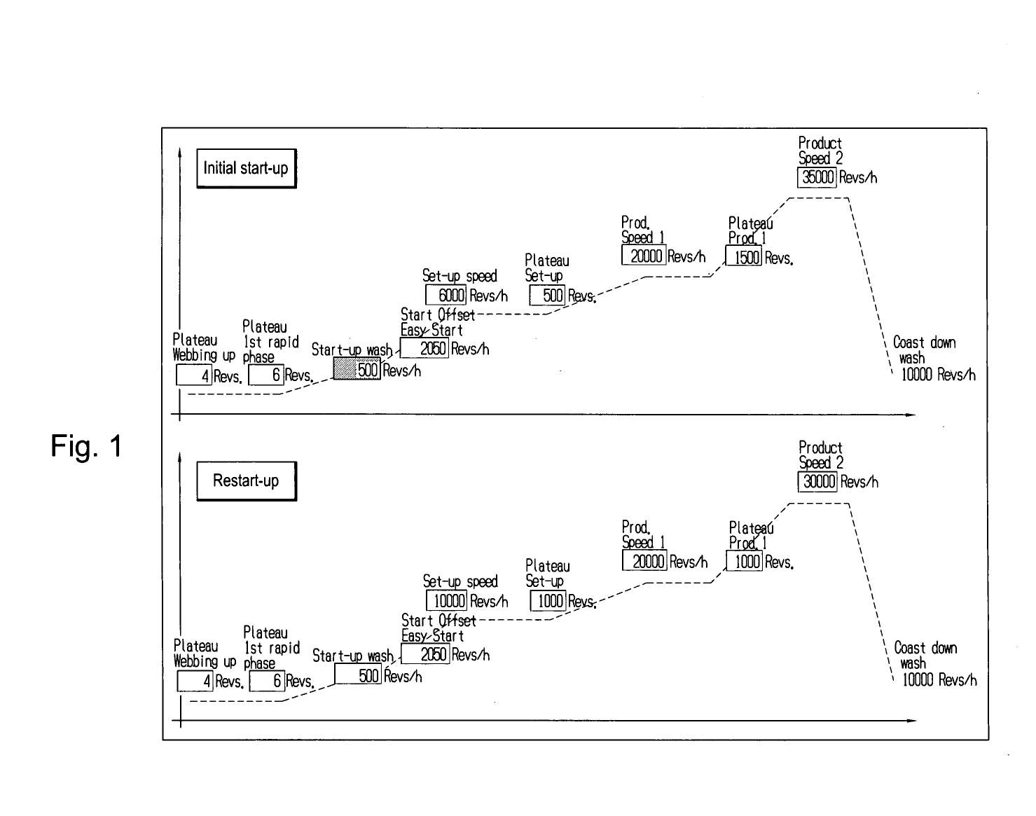

In what follows, first various processes, each for an automatically controlled acceleration of the rotary printing press, and all of which are executed in mutually coordinated process steps and monitored, will be specified by way of example with reference to a number of drawings. FIG. 1 shows a first program mask, preferably displayed on an optical display device of the control unit, which may be, for example, the control station. In the depicted embodiment this program mask is divided in two. The path of an initial start-up of the rotary printing press is displayed in its upper half and the path of a restart-up of the rotary printing press is displayed in its lower half. The two paths, which are preferably displayed simultaneously in this program mask, are each represented in the form of a diagram. The abscissa of each respective diagram is a time line. A production speed of the rotary printing press, that correlates to the transport speed of the paper web, is plotted on the ordinate of the respective diagram, each in values for a speed of the printing couple cylinders of this rotary printing press. Each of these depicted paths for an acceleration of the rotary printing press has a plurality of plateaus. At each such plateau, the speed of the printing couple cylinders of this rotary printing press remains at a specific value. In the respective time segment of constant speed of the printing couple cylinders of this rotary printing press at each such speed plateau, in each case, specific adjustment processes are to be executed by or in the units of the rotary printing press.

In FIG. 1, the respective paths for the initial start-up and for the restart-up of the press do not differ substantially from one another in principle, but only differ in a small number of the values for the speed of the printing couple cylinders of this rotary printing press assigned to the respective plateaus, differ at which values a certain plateau is reached, and/or differ in the number of revolutions of the printing couple cylinders of this rotary printing press, thereby establishing a certain duration of the time segment which is assigned to a certain plateau. For instance, after leaving the idle status, in the first phase of acceleration of the rotary printing press, the paper web is fed into the rotary printing press at a constant infeed speed of, for example, four revolutions of the printing couple cylinders. After another six revolutions of the printing couple cylinders, for example, the second phase of acceleration of the rotary printing press, called the “first rapid phase” is initiated. When the printing couple cylinders reach a speed of 500 revolutions per hour, for example, a so-called start-up washing of the printing couple cylinders is performed. When the printing couple cylinders reach a speed of 2,050 revolutions per hour, for example, the third phase of acceleration of the rotary printing press begins. In this third phase of acceleration, the previously discussed offset commands are engaged. This third phase of acceleration continues until the printing couple cylinders reach a speed of 6,000 revolutions per hour, for example. The speed of the printing couple cylinders is maintained at this plateau for another 500 revolutions of the printing couple cylinders, for example. After this, the speed of the printing couple cylinders is increased to a level of 20,000 revolutions per hour, for example, at which a first production speed is reached. The printing couple cylinders can remain at the level of this first production speed of the printing couple cylinders, for another 1,500 revolutions of the printing couple cylinders. After this number of revolutions, the printing couple cylinders are accelerated to the plateau of a second, for example, maximum production speed of 35,000 revolutions per hour, for example. When the print order upon which the current printing process is based has been completed, the speed of the printing couple cylinders of the rotary printing press is decelerated by the program running in the control unit, and thus the rotary printing press is decelerated automatically, back to the idle status, for example. During deceleration of the rotary printing press, when the printing couple cylinders reach a speed of 10,000 revolutions per hour, for example, a coast down washing of the printing couple cylinders can be provided.

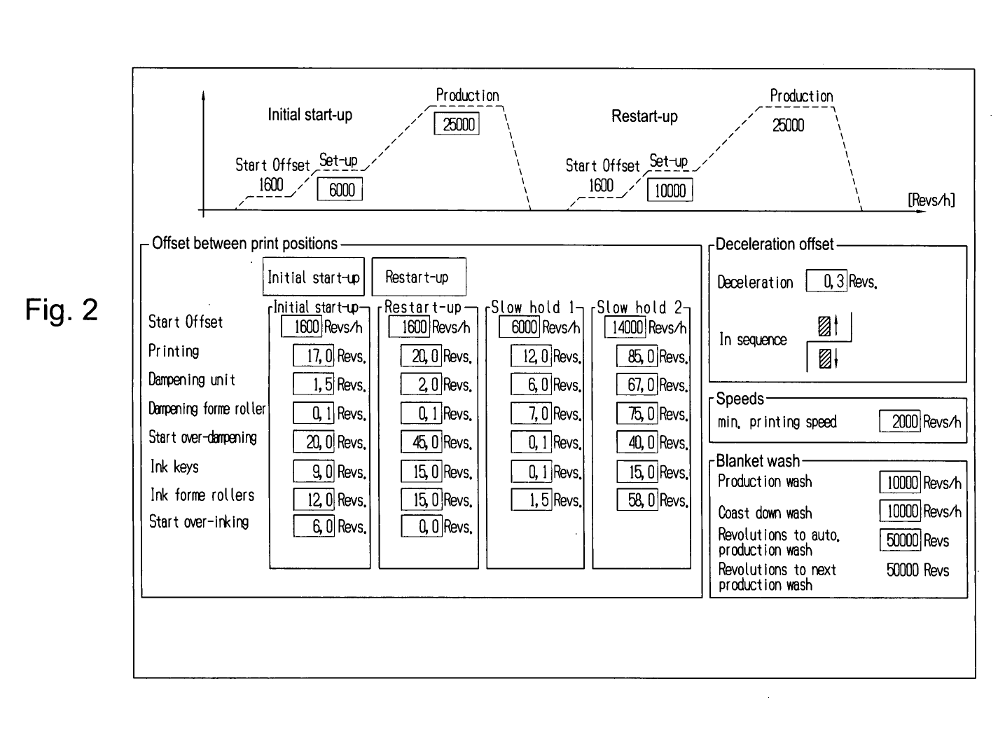

The path of the restart-up of the rotary printing press, which is also illustrated in FIG. 1 differs from its initial start-up in terms of only a small number of numerical values which are set at the control unit. Preferably, all of the aforementioned numerical values in the basic program can be variably adjusted at the control unit, and especially the speed of the printing couple cylinders and/or the speed of a roller arranged in an inking unit or dampening unit, and their respective period of action. A program mask for performing such adjustments of the numerical values is shown, by way of example, in FIG. 2. On one side of the program mask certain speeds for the printing couple cylinders are indicated, at which certain speeds, specific process steps, such as the offset commands are initiated. On the other side of the program mask, a specific number of revolutions of these printing couple cylinders are indicated, and which are assigned to specific offset commands, thereby defining the respective length of the time interval required for executing a specific offset command. The program mask for performing adjustments with respect to the acceleration of the rotary printing press preferably also contains fields for the adjustment of values for the deceleration of this rotary printing press. For instance, FIG. 2 shows preferred numerical values for the deceleration of the rotary printing press for two sequences that differ from one another at least in terms of their respective starting speeds.

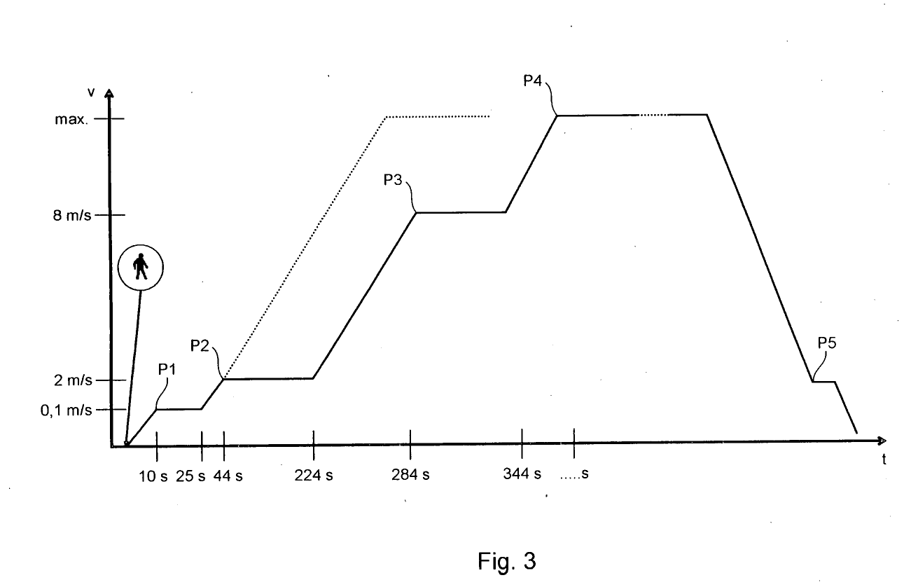

FIG. 3 shows a first example of a path of the acceleration of the rotary printing press which is to be executed automatically by the control unit. In this diagram examples of numerical values are plotted on both the abscissa and the ordinate, with the ordinate indicating the respective transport speed of the paper web. One possible path for the restart-up of the rotary printing press is indicated only by a dotted line. According to this acceleration path, in the represented example, 10 seconds after leaving the idle status, when the paper web is at a transport speed of approximately 0.1 m/s, a first plateau P1 is already reached. At this first plateau P1, the second phase of acceleration of the rotary printing press, called the “first rapid phase,” begins, and at which time, the necessary web tension is starting to build up in the paper web. 15 seconds later, or 25 seconds after the start of acceleration, the printing couple cylinders of the rotary printing press that are required for the pending printing process, and which convey the paper web by virtue of their rotation, are accelerated such that the paper web has a transport speed of 2 m/s, which transport speed is reached, for example, 44 seconds after the start of acceleration. At this point, the actual set-up phase of the rotary printing press begins. At a second plateau P2, which, at this aforementioned transport speed of the paper web lasts 180 seconds, for example, the above-mentioned offset commands are issued in a sequence which has been defined in the relevant control unit. The units of the rotary printing press, which will be required for the pending printing process, are thereby placed in an operating status that is usable for the printing process. At the end of this second plateau P2, at a time of 224 seconds after the start of acceleration, for example, first copies of the printed product to be produced are being produced in a saleable quality. In the subsequent 60 seconds, the transport speed of the paper web is accelerated to a level of approximately 8 m/s, for example, by increasing the speed of the printing couple cylinders of the rotary printing press. A third plateau P3, namely the plateau P3 of a first production speed of this rotary printing press, is now reached. This third plateau P3 of the first production speed of this rotary printing press can last another 60 seconds, for example, at which time, the transport speed of the paper web can again be accelerated, now to a maximum level, for example, by a further increase in the speed of the printing couple cylinders of the rotary printing press. A second production speed, for example the maximum production speed of this rotary printing press, is set by its control unit, which, in the represented acceleration curve, represents a fourth plateau P4. When the print order has been completed, the speed of the printing couple cylinders of the rotary printing press, and thus the transport speed of the paper web, is decreased again, for example to the idle status. During deceleration, when a fifth plateau P5 is reached, a coast down washing of the printing couple cylinders, which were involved in the preceding printing process, can be provided as needed. The program of the control unit initiates the execution of the coast down washing of the printing couple cylinders during deceleration of the rotary printing press. If it is necessary to re-accelerate the rotary printing press during processing of the same print order, the acceleration curve can also follow the path indicated by a dotted line in FIG. 3.

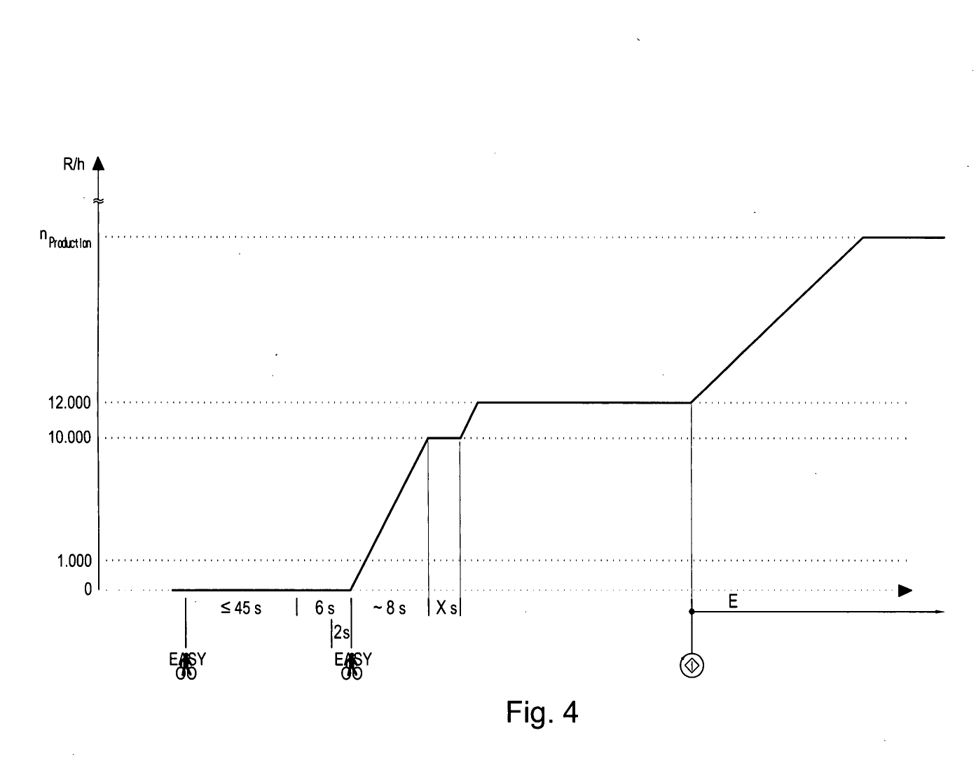

FIG. 4 shows a second example of a path for the acceleration of the rotary printing press, as may be automatically executed by the control unit. In this diagram, again, preferred numerical values are plotted on both the abscissa and the ordinate. However, in this case, the ordinate indicates the respective speed of the printing couple cylinders of the rotary printing press. In this example, a process sequence is specified which includes the use of a dryer within the rotary printing press, because heatset inks are being used for printing in the printing process, for example. This may be the case, for example, with semi-commercial printing applications.

When an operator of the rotary printing press starts the program for automatically executing acceleration of this rotary printing press, at the control unit belonging to this rotary printing press, which program is preferably implemented in the control unit in a memory unit, such as, for example, by actuating an operating element that is located on the control unit, an activation of this program, and thereby the start of acceleration, can be displayed, for example by an optical display, and in particular can be displayed by a blinking of the actuated operating element. When the operating element is actuated, for example, an inspection of the dryer of this rotary printing press, begins, and in particular an inspection determines whether its doors are closed and whether its nozzle bed is operational. After this first system check, a heating of this dryer to a temperature of 100° C., for example, also begins. If a correction in a setting of the dryer is necessary, a corresponding message is provided on the display device belonging to the control unit, such as, for example, on a monitor belonging to the control station, and requiring the operator of the rotary printing press to make a change in the setting of the dryer. Placing the dryer in operational readiness is completed in a maximum of 45 seconds, for example. When the dryer is operationally ready, a corresponding message, such as, for example, an optical message, is provided on the display device of the control unit. At the same time the dryer reaches operational readiness, preparations can be made initiating for a washing function for washing at least one printing blanket that is mounted on a transfer cylinder, for example, by activating a corresponding program. This washing function is only required if at least one of the printing couple cylinders of the rotary printing press, which are to be involved in the pending printing process is embodied as this type of transfer cylinder. This preparation time can last 6 seconds, for example. 2 seconds before this preparation period ends, for example, the control unit belonging to this rotary printing press will emit an acoustic signal in the form of a horn sound, for example. At the end of this preparation period, it may be necessary that the preferably still blinking operating element of the control unit be re-actuated to activate the program for automatically executing acceleration of this rotary printing press, in order to now initiate the start of rotation of the printing couple cylinders of the rotary printing press which are to be involved in the pending printing process. With the start of rotation of these printing couple cylinders of the rotary printing press, its dryer is heated to its ultimate operating temperature. Once the rotation of these printing couple cylinders of the rotary printing press reaches a speed of 1,000 revolutions per hour, for example, an execution of the previously prepared washing function for washing at least one printing blanket mounted on the transfer cylinder can be initiated, under the control of the program stored in the memory unit of the control unit. In the continuing acceleration phase of these printing couple cylinders of the rotary printing press, which continuing acceleration phase comprises a total duration of approximately 8 seconds, for example, the web tension of the paper web that is fed into the rotary printing press is preferably verified by suitably positioned sensors. At the dryer of the rotary printing press, an additional stage, such as, for example, a second, blowing stage can be included. When these printing couple cylinders of the rotary printing press reach a speed of approximately 10,000 revolutions per hour, the previously discussed first acceleration phase of these printing couple cylinders can be ended. The speed of the printing couple cylinders now remains at this level for a period X, which is variably adjustable, for example. This holding time period X is dependent, for example, upon the washing program, which may be executed at this time, for washing at least one printing blanket mounted on the transfer cylinder. When this holding time X has ended, the washing of at least one printing blanket that is mounted on the transfer cylinder is completed. A sequence now begins, in which sequence at least one of the printing couple cylinders of the rotary printing press, which is to be involved in the pending printing process, is engaged against another of these printing couple cylinders, in order to enable an execution of the pending printing process. When this holding time X has ended, the printing couple cylinders of the rotary printing press that will be involved in the pending printing process are also accelerated further, for example up to a speed of approximately 12,000 revolutions per hour. When the printing couple cylinders of the rotary printing press reach the latter speed, of, for example 12,000 revolutions per hour, the process steps that may be required for accomplishing the further set-up of this rotary printing press begin. These process steps can correspond to the offset commands which were described previously. If necessary, in this segment of acceleration of the rotary printing press, the operator of the rotary printing press may also intervene manually. At the end of this segment, the rotary printing press will begin to produce the first saleable copies E of the printed product to be produced in the current print order. In a not fully automatic process for accelerating the rotary printing press it may be required that the operator of this rotary printing press must then actuate an additional operating element, which may be, for example, also located on the control unit, in order to accelerate the printing couple cylinders of the rotary printing press, which printing couple cylinders are involved in the pending printing process, to another higher, preferably maximum production speed at a speed n_{production}. This manual operating step is omitted, however, in a fully automatic process for accelerating the rotary printing press, in which fully automatic process, the rotary printing press is automatically accelerated to its maximum production speed after the sole control command is issued by the program which is running in the control unit.

Assuming that the rotary printing press has, in combination with its units for adjusting web tension and for adjusting the ink application and for adjusting at least one longitudinal cut and/or one cross cut executed on the paper web, a web tension controller, an ink register controller, an ink density controller and/or a cut-off compensator controller, the previously-described, controlled acceleration of the rotary printing press can be expanded to include a control system that controls this acceleration automatically, at least up to at least one checkpoint which may be defined in advance. A controlled acceleration of the rotary printing press then runs in a sequence of steps as will be described in the following discussion, by way of example.

As has been described above, and following the actuation of a specific operating element, which may be for example, located on the control station, the process for accelerating the rotary printing press is started. The printing couple cylinders of the rotary printing press, which will be involved in the impending printing process, begin to draw the paper web constantly into the rotary printing press at the so-called maximum infeed speed of 5 m/s, for example. At the first plateau P1, as was described in connection with FIG. 3, the web tension controller inspects the web and determines whether there is sufficient web tension in the paper web. If necessary, the web tension controller regulates the existing web tension to a predetermined first target level. The “first rapid phase” then increases the web tension, and the web tension controller regulates the web tension, which is now present in the web, to a predetermined second target level. When this regulation goal is achieved, the rotary printing press accelerates its printing couple cylinders to the set-up speed, which set-up speed corresponds to the second plateau P2 of FIG. 3. There, the control unit belonging to this rotary printing press, automatically executes the offset sequence with the previously described offset commands. One component of this offset sequence involves the use of the ink register controller to control a register hold of the multiple printing couple cylinders of the rotary printing press that will be involved in the pending printing process. A multicolor printing, and in particular, a four-color printing, which is to be executed by this rotary printing press, will be executed without errors, and with at least adequate precision. The ink density controller also controls the ink density which is necessary to generate the printed product. If multiple layers of the paper web are required to generate the printed product, the cut-off compensator controller operates and controls these paper web layers, relative to one another, in their respective lateral offset and in their respective sections, and in particular with respect to their respective print images.

As soon as the ink register controller, the ink density controller and, if applicable, the cut-off compensator controller each report a successful control of the units they influence to the control unit of the rotary printing press, the waste paper sorting gate of the rotary printing press is program controlled to close. The control unit of the rotary printing press then accelerates its printing couple cylinders to the desired production speed, which typically is the maximum production speed of this rotary printing press. The control unit does this since it acts correspondingly upon the respective drives of these printing couple cylinders. In such a fully automatic control circuit, in which positive feedback from preceding process steps automatically releases subsequent process steps based upon criteria that has been established in advance, the first production speed, as depicted in FIG. 3 or in FIG. 4 is not required. The web tension controller, the ink register controller, the ink density controller, and, if applicable, the cut-off compensator controller continuously verify their respective adjustment and influence on the printing process, via sensors, for example, and are automatically readjusted when a deviation of a detected actual value from a predefined target value is identified. Thus, with a controlled acceleration of the rotary printing press, its control unit can continue to accelerate the printing couple cylinders right away, without maintaining an intermediate plateau P3, as shown in FIG. 3 or in FIG. 4, which enables a very rapidly executable acceleration of the rotary printing press. In the preferably controlled acceleration of the rotary printing press, it is therefore provided that at least at one checkpoint, which has been established in the program sequence and thus also in the path of the acceleration, the program, which is executed by the control unit, verifies an admissibility for continuing the acceleration based upon at least one condition for that admissibility which was defined in advance and, for example, taking into consideration measured data collected in the rotary printing press. The acceleration will be continued by the program only if the at least one condition defined for admissibility, which at least one condition is preferably stored in a memory of the control unit, is met with respect to this checkpoint. If one or if even multiple conditions for continuing acceleration that are valid at the relevant checkpoint are not met, the program will assume a malfunction has occurred. The acceleration of the rotary printing press can then be discontinued by the program or can at least be interrupted, thereby causing the rotary printing press to remain at an operating status which it occupied at the relevant checkpoint during its acceleration. Alternatively, if applicable, the acceleration can also be discontinued by the program via an automatic initiation of deceleration. Such a deceleration of the rotary printing press can be initiated, for example, after the rotary printing press has remained at the operating status, which it occupied at the relevant checkpoint during its acceleration, for a period of time that is deemed impermissibly long. At least, a message is sent to the operator of the rotary printing press.

In the discussion which follows, the above-described deceleration of the rotary printing press, which is frequently followed by a complete shutdown of the rotary printing press, will be specified in greater detail. The term shutdown comprises all of those activities that are necessary and which must be performed in order to bring the rotary printing press back to its initial status, so that it can be set up, such as, for example so that it can be, made ready for a new production process or for a subsequent production process.

The shutdown of the rotary printing press comprises essentially the following actions or process steps:

At least one guide roller that feeds a print substrate must be cleaned.

At least one remainder of the print substrate, for example of one or more material webs, and in particular one or more paper webs, which were being used in the preceding production process, must be removed from the rotary printing press if the new production process requires a different print substrate or requires a different number of material webs of the relevant print substrate.

At least one roller of an inking unit, and, if applicable, also at least one roller of a dampening unit of this rotary printing press, must be cleaned.

At least one printing blanket of a transfer cylinder that cooperates with the form cylinder, such as, for example, at least one so-called rubber blanket, must be cleaned.

At least one printing form, which had been used in the preceding production process, must be removed from its mounted position on a form cylinder of this rotary printing press.

All of these process steps of shutdown are often executed either manually by personnel operating the rotary printing press, or are executed automatically by special, individually actuated units that are arranged in the rotary printing press, such as a corresponding washing unit, which may be, for example, a blanket washing unit. These actions are typically executed individually, in succession, by a single operator, or are executed by multiple operators simultaneously, but independently of one another, each by an actuation of the respective unit.

For shutdown, it is also desirable for the actions that are part of the process of reconfiguring the rotary printing press, and which are executed by different units at different locations in the rotary printing press, to be started centrally at a control unit, such as, for example, at a control station of the rotary printing press, and after this start, for such actions to be executed automatically, on the basis of default specifications of a program running in the control unit. Accordingly, after the program start, the shutdown of the rotary printing press is executed automatically, without further actuation of a unit that executes the relevant action. The efficiency of the shutdown is thereby improved, because the shutdown is executed by a single printing press operator, and also because the shutdown is performed in a shorter time than is required for a conventional shutdown. This allows the rotary printing press to be available more quickly for further production. Its availability and thus its efficiency are improved.

The rotary printing press, which is shown schematically in FIG. 5, has at least one printing unit, by way of example, for four-color printing of both sides of a print substrate 12, preferably a material web 12. The printing unit is embodied as an eight-couple printing tower with a compact structure, for example. This eight-couple tower has a total of eight printing couples, with four printing couples arranged one above the other on each of the two sides of the material web 12. Each printing couple has at least one form cylinder 01, along with at least one transfer cylinder 02 that cooperates with the form cylinder 01. At least one inking unit 03 can be engaged against its associated form cylinder 01, and, if applicable, a dampening unit 04 can also be provided. The inking unit 03 and the dampening unit 04 each have at least one roller, and preferably each have multiple rollers 06. The printing unit which is shown in FIG. 5 is thus equipped with eight form cylinders 01, along with eight transfer cylinders 02, each of which cooperates with one of the form cylinders 01, and with eight inking units 03, each of which can be engaged against its respective one of the form cylinders 01, and, if applicable, is also equipped with eight dampening units 04. The inking units 03 and the dampening units 04 each have at least one, and preferably have multiple rollers 06. The form cylinders 01, the transfer cylinders 02 and at least one of the rollers 06, which are arranged in one of the inking units 03 and dampening units 04, each have a separate drive, which is not specifically shown, so that the relevant form cylinder 01 and/or the relevant transfer cylinder 02 and/or the relevant roller 06 of the inking unit 03 and/or the relevant roller 06 of the dampening unit 04 can be controlled, and actually are actuated, each individually by a suitable control unit, which is also not specifically shown, at least with respect to their respective rotational movement.

The form cylinders 01 can be single- or double-sized in terms of their diameter. In their single-sized embodiment, they can each accommodate only a single printing form along their outer surface. Each double-sized form cylinder 01 can accommodate two printing forms arranged, one in front of the other, along its outer surface. Both a single-sized form cylinder 01 or a double-sized form cylinder 01 preferably each cooperate with a double-sized transfer cylinder 02. The form cylinders 01 preferably have multiple mounting positions, such as, for example, four or six mounting positions, on their outer surfaces in their respective axial directions, each such mounting position being configured for the receipt of at least one printing form in the circumferential direction of the relevant form cylinder 01. However, multiple mounting positions, such as, for example, two such mounting positions, can also be provided at the respective axial positions of the relevant form cylinder 01 in the circumferential direction of the form cylinder 01.

In addition to the previously mentioned independent drive technology, this depicted rotary printing press has one device 07 for automatically changing at least one printing form, such as, for example, a so-called plate changer 07, on at least one of its form cylinders 01, and preferably on all of its form cylinders 01. At least one blanket washing device 08 is provided, which blanket washing device 08 can be engaged against one of the transfer cylinders 02. Preferably, each transfer cylinder 02 is equipped with such a blanket washing device 08. The inking unit 03 is also equipped with at least one inking roller washing device 09. The inking roller washing device 09 preferably has at least one washing blade that can be engaged against one of the rollers 06 of its associated inking unit 03. In a rotary printing press that has at least one dampening unit 04, a bridge roller 11 is provided for use in connecting the relevant inking unit 03 to the dampening unit 04. Upstream of the intake of the print substrate 12, for example the material web 12 that is continuously unwound from a reel, into the printing unit, a cut-off device 13 is arranged. Such a cut-off device 13 is usable for dividing the material web 12, as needed, crosswise to its transport direction, thereby separating it from its respective reel. At various locations in the rotary printing press, such as, for example, in the intake of the print substrate 12 into the printing unit or in the superstructure of the rotary printing press, preferably at least one guide roller 14 for guiding the print substrate 12 is arranged, and which at least one guide roller 14 can have a guide roller washing device 16, for example. All of the aforementioned units, for example, the respective drive of the respective form cylinder 01, the respective drive of the respective transfer cylinder 02, the respective drive of at least one roller 06 of the respective inking unit 03 and/or the respective drive of at least one roller 06 of the respective dampening unit 04 and the respective device 07 for automatically changing at least one printing form on one of the form cylinders 01, the blanket washing device 08, the inking roller washing device 09, preferably along with its washing blade, the cut-off device 13 and, if applicable, also the guide roller washing device 16 are each remotely controllable, and preferably are all remotely controlled, centrally via a preferably electronic control unit, such as, for example, via a control station that is a part of the rotary printing press. The rollers 06 of the inking unit 03 and the rollers 06 of the dampening unit 04, and, if applicable, a bridge roller 11, which is situated between the inking unit 03 and the dampening unit 04, and also the at least one guide roller 14 that guides the print substrate 12 and the form cylinder or cylinders 01 and the transfer cylinder or cylinders 02 of the rotary printing press, and, if applicable, an impression cylinder that cooperates with at least one transfer cylinder 02 are generally also referred to as rotational bodies of the rotary printing press.

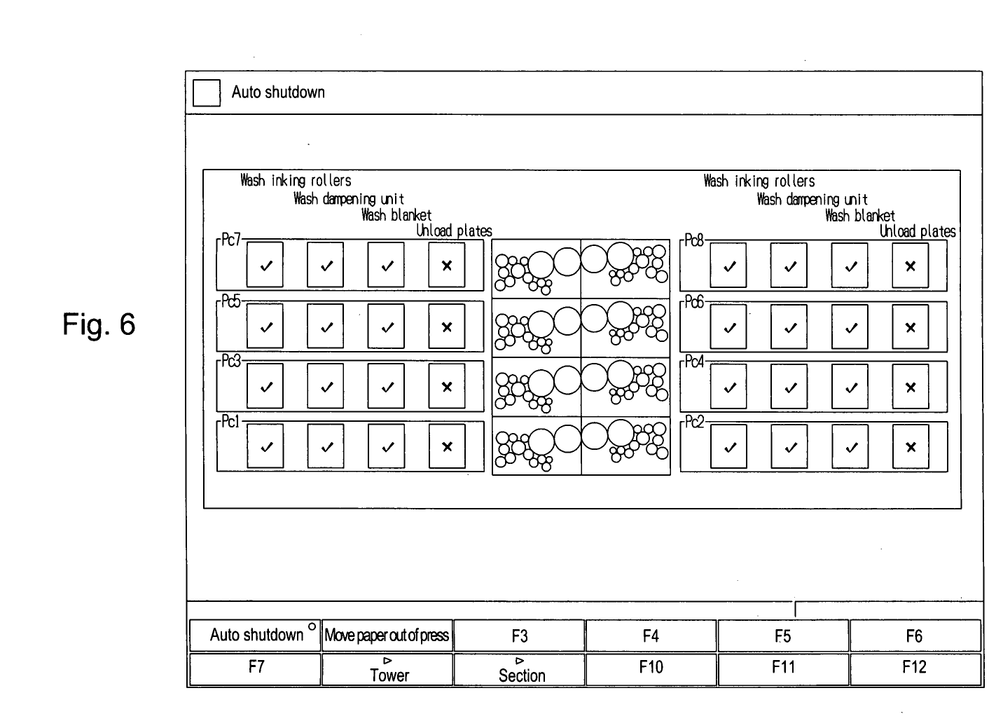

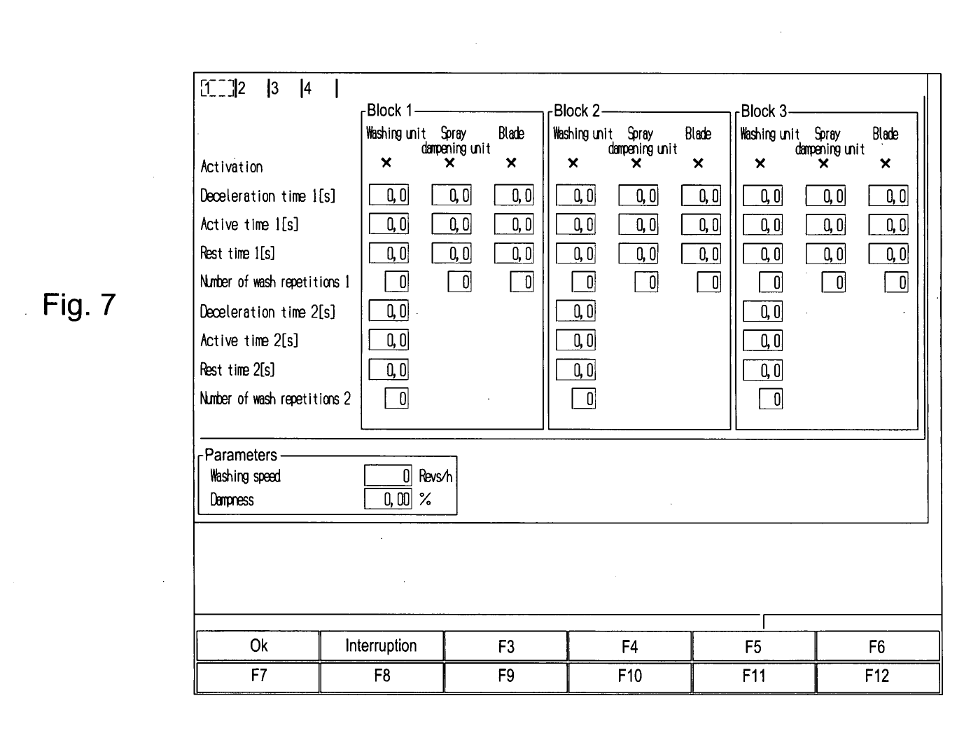

The control unit is connected to at least one operating unit and to at least one display unit. With the operating unit, an additional program, or a program that supplements the program for accelerating the rotary printing press and that also runs in the control unit, and which controls the shutdown of the rotary printing press, can be selected and activated. Individual process steps of the shutdown can be displayed on the display device in a corresponding program mask and can be selected there as needed. The individual selected process steps of the respective units in the rotary printing press are then automatically executed, either in parallel, for example, essentially simultaneously, or successively. The program that controls the process of shutdown actuates the respective units according to a sequence which is defined in the program. FIG. 6 and FIG. 7 each show an example of a program mask from the program for executing the shutdown process.

Using the operating unit of the control unit, such as, for example, a pointer instrument or a keyboard, the operator of the rotary printing press selects the desired process steps for executing the shutdown process in the program mask shown in FIG. 6. These steps are selected preferably for each of the printing couples, for example, for the eight printing couples, of the printing unit illustrated by way of example, the units of these printing couples to be actuated. The selector having the function “auto shutdown” is then selected in the program mask, thereby causing the sequence of this program or of this program segment to start in the selected units. If the rotary printing press has multiple printing units, the respective printing unit can also be selected in the program mask on the display device before the described adjustments are made. The parameters of the individual units, that relate, in particular, to shutdown steps, are adjusted in a program mask according to FIG. 7, for example. These parameters relate, for example, to a duration and/or to a temporal status and/or to a number of repetitions of individual washing processes or to an engagement time or a disengagement time for the respective washing blade. These parameters are adjustable, for example, for each of the inking roller washing devices 09 and for each of the washing blades which are present in one of the inking units 03, each individually and preferably also each independently of other inking roller washing devices 09 or washing blades. As another parameter, for example, the speed of the relevant transfer cylinder 02 or of the relevant roller 06 of the respective inking unit 03 or of the relevant roller 06 of the respective dampening unit 04 or of the relevant guide roller 14, which is to be executed during the washing process, can be adjusted.

The automated shutdown process begins, for example, with a washing of one or more guide rollers 14. In this process, the print positions, which were involved in the preceding production process, along with all of the infeed elements which were used to convey the material web or webs 12 in the printing unit, and also a folder, that is situated downstream of the printing unit, are activated at their respective infeed speed. That infeed speed can mean a transport speed of approximately 5 m/min. for the material web or webs 12, for example. A washing agent is also applied to each of the material webs 12. The guide rollers 14 that are in contact with this material web 12 or with these material webs 12 are decelerated at preferably multiple separate intervals. Any dirt which may be coating these guide rollers 14 is removed by the respective material web 12, which has been impregnated with the washing agent and which web 12 is moved through the printing unit and, if applicable, is also moved through the folder that is situated downstream of the printing unit. This web 12 is moved at a transport speed that is lower than the full production speed.

When the cleaning of the guide rollers 14 has been completed, the print positions, which were involved in the preceding production process, along with all of the infeed elements that convey the material web or webs 12 in the printing unit and the rotation elements that convey the material web or webs 12 in the folder are accelerated to a circumferential speed which corresponds to approximately 5% of the full production speed, for example. When the transport speed, corresponding to this circumferential speed of the conveyed material web or webs 12, is reached, the cut-off device 13, that is located upstream of the respective printing unit, is initiated, and the respective material web 12 is separated from its respective reel.

In a rotary printing press having multiple printing units, a material web 12 can ordinarily be guided and conveyed along various web paths. The length of each of the respective web paths is known. A calculated value, which corresponds to the respective web path length, is stored in a memory of the control unit which controls the shutdown process. Once the material web 12 having the longest web path has reached the folder belonging to the rotary printing press, the material web 12 having the longest web path, and, if applicable, additional material webs 12, which have also been guided through this rotary printing press to the same folder, are held in their respective transport movement. With the execution of this process step, the rotary printing press is freed of all of the material webs 12 which were involved in the preceding production process. There is thus no longer any more material web 12 in the printing units belonging to this rotary printing press. This process step is activated in the program mask shown in FIG. 6 by the use of a selectable tab in the program that controls the shutdown process, as shown in the bottom strip. Any remainder of one or more of the material webs 12 that were involved in the preceding production process can then also be removed from the folder belonging to the rotary printing press.

The shutdown process, which is shown in accordance with the program mask of FIG. 6, provides that in each of the printing couples, that had been involved in the preceding production process, the inking unit 03 and the associated dampening unit 04 are washed, as in the illustrated program mask. The selection surfaces which are assigned to these units are also selected by the use of the operating unit belonging to the control unit, thereby activating the respective process step to be executed according to the program. In practice, a link is preferably provided between the functions “wash inking unit or inking rollers” and “wash dampening unit,” which link can be selected by selection surfaces in the program mask. Such a link provides that an activation of the function “wash dampening unit” necessarily also leads to an activation of the function “wash inking unit or inking rollers.” The program preferably insures that the dampening unit 04 can be washed only simultaneously while also washing the inking unit 03. It is possible, however, to wash only the inking unit 03, without initiating a washing process of the dampening unit 04.

During washing of the inking unit 03, and specifically during washing of its rollers 06, a washing agent is applied to at least one of these rollers 06 by the inking roller washing device 09. The inking roller washing device 09 typically has a spray bar, for example, which sprays the washing agent onto the outer surface of the assigned roller 06. During washing of the dampening unit 04, a dampening agent, such as, for example, water, is applied to at least one of the rollers 06 of this dampening unit 04. The dampening unit 04 may be embodied, for example, as a spray dampening unit 04, so that the dampening agent is also sprayed, via a spray bar, onto the outer surface of a roller 06 which is assigned to that spray bar. In each printing couple, the roller train of the inking unit 03 and that of the dampening unit 04 are connected to one another via a bridge roller 11. Such a bridge roller 11 is engaged between the inking unit 03 and the dampening unit 04 at least for the duration of the process of cleaning that inking unit 03 and that dampening unit 04. Excess washing agent, which may have been applied to the rollers 06 of the inking unit 03, can be squeegeed off by the washing blade of the inking roller washing device 09. The duration and/or the temporal status and/or the number of repetitions of individual washing processes in the inking unit 03 and/or in the dampening unit 04, together with engagement and disengagement times for the washing blades, are preferably variably adjustable at the control station, for example, in accordance with the program mask shown in FIG. 7. A value adjustment of these parameters is dependent, for example, upon the materials which are used in the printing process, such as, for example, the print substrate, the ink, or a surface quality of the rotational body that guides and/or that conveys the print substrate and/or the ink.

To execute the process step of washing the inking unit 03, its rollers 06 are rotationally accelerated and are adjusted to a variably selectable washing speed ranging from 3,000 to 6,000 revolutions per hour, for example. When, by a corresponding selection, for example, in the program mask shown in FIG. 6, for example, a washing of the dampening unit 04 is also planned, first the bridge roller 11 is engaged between the inking unit 03 and the dampening unit 04. Only after that engagement, are the rollers 06 of the inking unit 03 and those of the dampening unit 04 accelerated and adjusted to the aforementioned washing speed ranging from 3,000 to 6,000 revolutions per hour, for example. In both cases, with or without washing of the dampening unit 04, after the washing speed is set, the previously described roller washing program is executed. When the roller washing program has been completed, the rollers 06 of the inking unit 03 and, if applicable, also the rollers 06 of the dampening unit 04 are decelerated to their respective idle status. A release for the subsequent process step can then be issued by the program.

If, as depicted in the program mask of FIG. 6, a washing of a blanket, which is mounted on a transfer cylinder 02, is selected for at least one printing couple, the blanket washing device 08 that is assigned to this transfer cylinder 02 is activated. This is done once any remainder of one or more of the material webs 12, which had been involved in the preceding production process, has been removed from the rotary printing press, and preferably is also done simultaneously with the process step of washing the inking unit 03, assuming that this latter process step has also been selected. The transfer cylinder 02 is accelerated to its washing speed, which washing speed can be variably adjusted within a range of, for example, 3,000 to 10,000 revolutions per hour. The associated washing program can be selected in the program mask shown in FIG. 6 as the function “end washing without paper,” for example, and can be released for execution. During execution of the process step of washing the at least one blanket on the transfer cylinder 02, a supply of ink in the inking unit 03 is deactivated. Preferably the transfer cylinder 02 is also disengaged from its impression cylinder. In the example which is shown in FIG. 5 that impression cylinder is the transfer cylinder 02 of another printing couple. When washing of the blanket is completed, the relevant transfer cylinder 02 is decelerated from its washing speed to its idle status. The program can then issue a release for a subsequent process step in the shutdown process, or can send a message to the control station indicating the end of the shutdown process, if the shutdown process will be ended with the washing of the blanket. A process step that will be executed after the blanket is washed can consist, particular, in that in at least one selected printing couple, at least one printing form which had been used in the preceding production process, is removed. Such a printing form removal is preferably accomplished fully automatically, from the printing form's mounted position on the associated form cylinder 01, with the help of the associated plate changer 07. The steps that constitute the shutdown of the rotary printing press can, however, also include a removal of multiple printing forms which had been used in the preceding production process. These printing forms are used on one of the form cylinders 01 of this rotary printing press, each at different mounting positions on the same form cylinder 01, in its axial direction and/or in its circumferential direction. Following this process step, which is most frequently called “plate unloading,” the message indicating the end of the shutdown process is finally sent to the control unit that controls the shutdown process. The shutdown process is then completed.

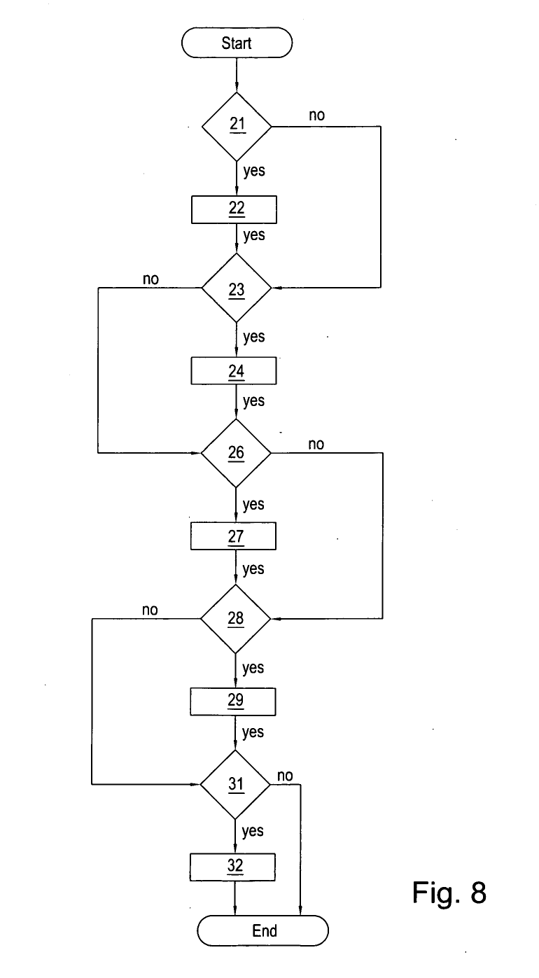

The sequence of the shutdown process will be specified again in reference to the flow chart of FIG. 8. The program sequence begins with the program that controls the shutdown process being started, for example at a control station belonging to the rotary printing press, by issuing the “Start” command. This command preferably centrally activates and remotely controls all of the steps which may be connected with shutting down the rotary printing press. At this time, the parameters for all of the units which may be involved in the shutdown process, are preferably already set through corresponding inputs or selections on at least one program mask displayed on the display unit.

In a first query 21, the started program checks whether this shutdown process includes a cleaning of at least one guide roller 14. If the answer to this question is yes, cleaning of the selected guide roller 14 is executed in process step 22. Otherwise, the program will skip to the next query 23. This second query 22 is whether any remainder of print substrate 12 from the preceding production process conducted in the rotary printing press will be removed from the rotary printing press. If the answer is “yes”, the removal from the rotary printing press is executed in process step 24. Otherwise, the program will skip to another query 26. This query 26 is whether at least one inking unit 03 or whether an inking unit 03, together with a dampening unit 04, will be cleaned. If this step has been provided for, according to the selection and the settings in the corresponding program mask, the cleaning of the inking unit 03 and/or the dampening unit 04 is executed in process step 27. If this process step 27 of cleaning the inking unit 03 and/or the dampening unit 04 will be dispensed with, the program will skip to another similarly oriented query 28. This fourth query is whether at least one printing blanket of one of the transfer cylinders 02 will be cleaned. If the answer is “yes”, the relevant printing blanket will be cleaned in process step 29. Otherwise, the program sequence will again skip to another, fifth query 31, namely whether at least one printing form will be removed from at least one form cylinder 01. If the answer is “yes”, the relevant printing form will be removed from the relevant form cylinder 01 in process step 32, using a device 07 for automatically changing the at least one printing form. If this is not planned, the sequence of the program for executing the shutdown process can be ended with the query 31 for removing at least one printing form on at least one form cylinder 01.

Rather than in the sequential order, as shown in FIG. 8, the process steps 27 and 29, which relate to the cleaning of the inking unit 03 and/or the dampening unit 04 or to the cleaning of the printing blanket, can be executed simultaneously, such as, for example, in parallel, and side by side, thereby again accelerating the shutdown process. Once process steps 22; 24; 27 and 29 have been executed, it is advantageous to issue a release for a subsequent program step according to the program. This can be done by sending a corresponding message to the control unit which controls the shutdown process. No later than after the process step 32 of plate unloading, a message, indicating the end of the shutdown process, is sent to the control unit. With the sending of this message, the shutdown process is ended, and the rotary printing press is again ready for set-up for a new print order.

While preferred embodiments of a method for accelerating a rotary printing press, in accordance with the present invention, have been set forth fully and completely hereinabove, it will be apparent to one of skill in the art that various changes in, for example, the specific structure of the printing units, the specific arrangement of the control panel, the type of operating units used, and the like could be made without departing from the true scope and spirit of the present invention which is accordingly to be limited only by the appended claims.

What is claimed is:

1-27. (canceled)

28. A method for accelerating a rotary printing press from an idle state including;
providing a control unit for said rotary printing press;
providing a program in said control unit;
adjusting parameter that influences said acceleration of such rotary printing press at said control unit;
accelerating said rotary printing press from said idle states following initiation of a single control command at said control unit;
using said program for verifying the admissibility for continuing the acceleration of said rotary printing press based on at least one defined admissibility condition;
performing said verifying of said admissibility for continuing the acceleration of said rotary printing press at least at one checkpoint defined in the course of the acceleration; and
one of decelerating and interrupting the acceleration of said rotary printing press using said program if said at least one defined admissibility condition fails to be met.

29. The method of claim 28 further including accelerating said rotary printing press from said idle state at least up to a first production speed.

30. The method of claim 28 further including using said program for controlling said acceleration.

31. The method of claim 28 further including providing a control circuit using said control circuit for accelerating said printing press fully automatically.

32. The method of claim 28 further including initiating said deceleration of said printing press when said failing of said defined admissibility condition remains for a time period deemed unacceptably long.

33. The method of claim 28 further including providing units in said rotary printing press, involving said units in executing a pending printing process and automatically activating and adjusting said units for executing said pending printing process.

34. The method of claim 28 further including collecting measured data in said rotary printing press and verifying said admissibility for continuing said acceleration using said measured collected data.

35. The method of claim 28 further including using said control unit for adjusting a web tension of a paper web to be printed in said rotary printing press.

36. The method of claim 28 further including providing multiple printing couple cylinders in said rotary printing press, using said multiple printing couple cylinders for printing a product, providing an ink register controller for controlling a register hold of said multiple printing couple cylinders and providing said ink register controller in said control unit.

37. The method of claim 28 further including providing an ink density controller in said control unit and using said ink density controller for controlling an ink density required to produce a printed product.

38. The method of claim 28 further including providing a cut-off compensator controller in said control unit and using said cut-off compensator controller for controlling relative lateral offset and respective cut-offs of multiple layers of a paper web printed by said rotary printing press.

39. The method of claim 28 further including providing a dryer belonging to said rotary printing press and using said control unit for controlling an operational readiness of said dryer during said acceleration of said rotary printing press.

40. The method of claim 28 further including using said control unit and initiates a washing of at least one printing blanket mounted on a transfer cylinder of said rotary printing press.

41. The method of claim 28 further including providing a waste paper sorting gate and using said control unit for selectively actuating said waste paper sorting gate.

42. The method of claim 28 further including a display device on said control unit and displaying said parameters that influence said acceleration of said rotary printing press on said display device.

43. The method of claim 28 further including automatically accelerating said rotary printing press at an initial start-up and at a restart-up of said rotary printing press.

44. The method of claim 28 further including using a first acceleration curve during an initial start-up of said rotary printing press and using a second acceleration curve during a restart-up of said rotary printing press.

45. The method of claim 28 further including providing a display device on said control unit, providing acceleration curves for an initial start-up and for a restart-up of said rotary printing press and displaying said acceleration curves on said display device in the form of a diagram.

46. The method of claim 45 further including providing a program mask on said display device and displaying said acceleration curves of said initial start-up and of said restart-up simultaneously in said program mask.

47. The method of claim 28 further including accelerating said rotary printing press automatically to a maximum production speed following said initiation of said single control command at said control unit.

48. The method of claim 28 further including sending a message to a press operator if said at least one defined admissibility condition fails to be met.

49. The method of claim 28 further including using said control unit and automatically initiating said decelerating of said rotary printing press following completion of a print order executed following said acceleration.

50. The method of claim 28 further including using said control unit and executing a coast down wash of printing couple cylinders of said rotary printing press during said decelerating of said rotary printing press.

51. The method of claim 28 further including using said rotary printing press for newspaper printing.

52. The method of claim 28 further including using said rotary printing press and executing an offset printing process.

53. The method of claim 28 further including using said rotary printing press in multicolor printing.
